(19) United States
(12) Patent Application Publication
(10) Pub. No.: US 2022/0026859 A1
(43) Pub. Date: Jan. 27, 2022

(54) MULTI-UNIT COOPERATIVE DISTRIBUTED ELECTRICAL CONTROL SYSTEM AND ELECTRICAL SYSTEM

(71) Applicant: Delta Electronics (Shanghai) Co., Ltd., Shanghai (CN)

(72) Inventors: Jian LI, Shanghai (CN); Qingsong TAO, Shanghai (CN); Guojin XU, Shanghai (CN); Guoqiao SHEN, Shanghai (CN); Jinfa ZHANG, Shanghai (CN)

(21) Appl. No.: 17/377,392

(22) Filed: Jul. 16, 2021

(51) Int. Cl. G05B 9/03; H04L 1/00

(52) U.S. Cl. CPC G05B 9/03; H04L 67/12; H04L 1/0056

(57) ABSTRACT

The present application provides a multi-unit cooperative distributed electrical control system and an electrical system. The control system includes multiple type-I embedded control units and at least one type-II embedded control unit, and a type-I embedded control units communicates with another type-I embedded control unit through the at least one type-II embedded control unit. A first type-I embedded control unit generates, according to functional information stored therein, a functional data packet, and then forwards the functional data packet to an adjacent second type-I embedded control unit through the type-II embedded control unit, so that the second type-I embedded control unit determines whether the received functional data packet passes a checking; if passed, the second type-I embedded control unit performs a corresponding operation; if not passed, do not perform a corresponding operation or it is determined that the functional data packet is abnormal.

### CROSS-REFERENCE TO RELATED APPLICATION

This application claims priority to Chinese Patent Application No. 202010711340.0, filed on Jul. 22, 2020, which is hereby incorporated by reference in its entirety.

### TECHNICAL FIELD

The present application relates to the field of control technology and, in particular, to a multi-unit cooperative distributed electrical control system and an electrical system.

### BACKGROUND

With the rapid development of new energy technology, whether it is for photovoltaic or wind energy control systems, compared with traditional centralized control systems, the multi-unit cooperative distributed control system is widely used as a new type of control system due to its advantages such as high flexibility in a control process and wide applicability.

Generally, the multi-unit cooperative distributed electrical control system realizes the control for one or more corresponding functions of the system through mutual cooperation between respective control units, where the control unit includes a type-I embedded control unit and a type-II embedded control unit. Each type-I embedded control unit is used to complete its own safety function, and the type-II embedded control unit is used to connect adjacent type-I embedded control units through a communication protocol, so that the respective type-I embedded control units cooperate to complete the entire control process for corresponding functions of the system.

Since each type-I embedded control unit has its own independent safety function, when it is used in the control system for the entire control process, related certification for the type-I embedded control unit from a third-party certification agency is needed to ensure the reliability of the control process of the control system. However, in the control process, software and/or hardware updates and communication signal interruptions that often occur in the type-II embedded control unit will cause errors in the control process between the type-I embedded control units, resulting in invalidity of the related certification. At this time, recertification is needed to avoid impacts on the reliability of the control system.

### SUMMARY

The present application provides a multi-unit cooperative distributed electrical control system and an electrical system to solve the technical problem that certification of a relevant embedded control unit in the existing multi-unit cooperative distributed electrical control system will fail and affect the reliability of the electrical system.

In a first aspect, the present application provides a multi-unit cooperative distributed electrical control system including at least two type-I embedded control units and at least one type-II embedded control unit, where one of the type-I embedded control units communicates with the other type-I embedded control unit through the at least one type-II embedded control unit;

where a first type-I embedded control unit generates, according to functional information stored therein, a functional data packet, and sends the functional data packet to the type-II embedded control unit, the type-II embedded control unit sends the functional data packet to an adjacent second type-I embedded control unit, and the functional data packet includes functional information and feature code information;

the second type-I embedded control unit determines whether the received functional data packet passes a checking;

if the checking is passed, the second type-I embedded control unit performs a corresponding operation according to the functional information;

if the checking is not passed, the second type-I embedded control unit does not perform a corresponding operation or determines that the received functional data packet is abnormal.

In a second aspect, the present application provides an electrical system including a multi-unit cooperative distributed electrical control system described in any one of the first aspect, where the electrical system includes multiple electrical units, and multiple type-I embedded control units of the control system correspondingly control one or more electrical units.

According to the multi-unit cooperative distributed electrical control system and the electrical system provided in the present application, the control system includes multiple type-I embedded control units and at least one type-II embedded control unit, and a type-I embedded control units communicates with another type-I embedded control unit through the at least one type-II embedded control unit. A first type-I embedded control unit generates, according to functional information stored therein, a functional data packet including functional information and feature code information, and then sends the functional data packet to the type-II embedded control unit through communication, so that the functional data packet is sent to an adjacent second type-I embedded control unit through the type-II embedded control unit. The second type-I embedded control unit determines whether the received functional data packet passes a checking; if the checking is passed, the second type-I embedded control unit performs a corresponding operation according to the functional information; if the checking is not passed, the second type-I embedded control unit does not perform a corresponding operation. Therefore, safety and reliability of the electrical system can be ensured based on the functional data packet, there is no need to consider invalidity of certification of a type-I embedded control unit due to hardware and/or software updates and communication interruptions in the type-II embedded control unit, and thus validity of related certification of the type-I embedded control unit is ensured.

### BRIEF DESCRIPTION OF DRAWINGS

In order to more clearly describe the technical solutions in the embodiments of the present application, the following will briefly introduce the drawings that need to be used in the description of the embodiments. Obviously, the drawings in the following description are some embodiments of the present application. For those of ordinary skill in the art, other drawings can be obtained based on these drawings without creative labor.

FIG. 1 is a schematic diagram of an application scenario of a multi-unit cooperative distributed electrical control system according to an embodiment of the application;

FIG. 2 is a schematic structural diagram of another control system according to an embodiment of the application;

FIG. 3 is a schematic diagram of a control process according to an embodiment of this application;

FIG. 4 is a schematic diagram of a timeliness check process according to an embodiment of the application;

FIG. 5 is a schematic diagram of another timeliness check process according to an embodiment of the application;

FIG. 6 is a schematic diagram of a checking process of a functional data packet according to an embodiment of the application;

FIG. 7 is a schematic structural diagram of an electrical system according to an embodiment of the application;

FIG. 8 is a schematic structural diagram of another electrical system according to an embodiment of the application; and

FIG. 9 is a schematic structural diagram of an electronic device according to an embodiment of the application.

### DESCRIPTION OF EMBODIMENTS

Here, exemplary embodiments will be described in detail, and examples thereof are shown in the accompanying drawings. When the following description refers to the drawings, unless indicated otherwise, the same numbers in different drawings indicate the same or similar elements. The implementations described in the following exemplary embodiments do not represent all implementations consistent with the present application. On the contrary, they are only examples of methods and apparatuses consistent with some aspects of the application as detailed in the appended claims.

The terms “first”, “second”, “third”, “fourth”, etc. (if any) in the description and claims of this application and the aforementioned drawings are used to distinguish similar objects rather than being used to describe a specific order or sequence. It should be understood that the data used in this way is interchangeable under appropriate circumstances, so that the embodiments of the present application described herein, for example, can be implemented in a sequence other than those illustrated or described herein. In addition, the terms “include” and “have” and any variations of them are intended to cover non-exclusive inclusion, for example, processes, methods, systems, products, or devices that include a series of steps or units are not necessarily limited to those steps or units that are clearly listed, but may include other steps or units that are not clearly listed or are inherent to these processes, methods, products, or devices.

The multi-unit cooperative distributed electrical control system is widely used due to its advantages such as high flexibility and wide applicability. The entire electrical control system is installed, arranged, and operated at the application site, and each control unit in the electrical control system is distributed on site. Generally speaking, the multi-unit cooperative distributed electrical control system realizes the control for one or more corresponding functions of the entire control system through mutual cooperation among respective control units, where the control unit includes a type-I embedded control unit and a type-II embedded control unit. Each type-I embedded control unit and type-II embedded control unit have respective specific functions, and adjacent embedded control units are connected through a communication protocol, so that the type-I embedded control unit and/or the type-II embedded control unit can complete the entire control process of the control system based on the communication protocol.

However, when each type-I embedded control unit performs its own functional control, taking the safety function as an example, it needs to be certified by a third-party certification agency to ensure the safety and reliability of the control system. However, during the use of the control system, the type-II embedded control unit often has hardware and/or software updates, or the communication signal may be interrupted. The occurrence of such situations will cause errors in the safety function of the type-I embedded control unit, leading to invalidity of related certification. In order to ensure the safety and reliability of the control system and even the electrical system including the control system, re-certification is required, which has impacts on the development costs of the control system.

In light of the above problem, in order to avoid re-certification and to ensure the safety and reliability of the electrical system, a multi-unit cooperative distributed electrical control system and an electrical system are provided in the present application. The control system includes at least two type-I embedded control units and at least one type-II embedded control unit, and a first type-I embedded control unit communicates with a second type-I embedded control unit through the at least one type-II embedded control unit. The first type-I embedded control unit generates, according to functional information stored therein, a functional data packet including functional information and feature code information, and then sends the functional data packet to the type-II embedded control unit through communication, so that the functional data packet is sent to an adjacent second type-I embedded control unit through the type-II embedded control unit. The second type-I embedded control unit determines whether the received functional data packet passes a checking; if the checking is passed, the second type-I embedded control unit performs a corresponding operation according to the functional information; if the checking is not passed, the second type-I embedded control unit does not perform a corresponding operation or determines that the received functional data packet is abnormal. Since the type-I embedded control unit that receives the functional data packet checks the functional data packet, the safety function is further executed when the checking is passed. Therefore, based on the functional data packet, the safety and reliability of the control system can be ensured, and invalidity of certification due to hardware and/or software updates and communication interruptions in the type-II embedded control unit can be avoided, thereby ensuring validity of related certification of the type-I embedded control unit.

Hereinafter, an exemplary application scenario of the embodiment of the present application will be introduced.

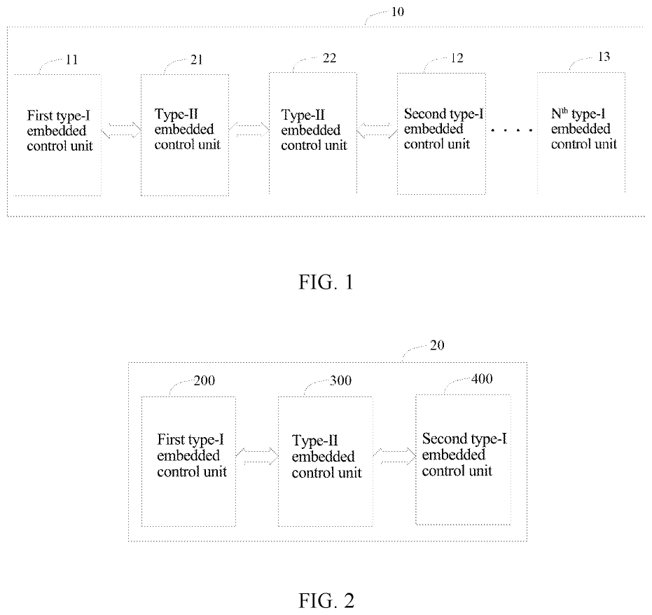

FIG. 1 is a schematic diagram of an application scenario of a multi-unit cooperative distributed electrical control system according to an embodiment of the application. As shown in FIG. 1, the electrical control system provided in the embodiment of the present application is applied in data interaction among multiple units to jointly complete control functions of a system. Among them, the control system 10 includes multiple type-I embedded control units, such as a first type-I embedded control unit 11, a second type-I embedded control unit 12, etc., up to an N^{th} type-I embedded control unit 13. There is at least one type-II embedded control unit 21 between respective adjacent type-I embedded control units, where the type-II embedded control unit 21 is used to realize communications between two adjacent type-I embedded control units and to perform its own specific function, so that data interaction between respective type-I embedded control units is performed, thereby realizing the entire control process. As shown in FIG. 1, type-I embedded control units are arranged from the first type-I embedded control unit 11 to the N^{th} type-I embedded control unit 13. The number of type-I embedded control units and type-II embedded control units can be specifically set according to the functions to be realized by the control system. There may be one or more type-II embedded control units between every two adjacent type-I embedded control units. As shown in FIG. 1, there are two type-II embedded control units 21 and 22 between the first type-I embedded control unit 11 and the second type-I embedded control unit 12. For each type-I embedded control unit, function information of the embedded control unit is stored in the embedded control unit, and the functional information can be run by a software program to complete the control of corresponding functions. It can be understood that the electronic device executes corresponding software programs to complete function controls, and the electronic device may be a chip or a terminal device. All embedded control units may be controlled by the same electronic device, or each embedded control unit may be provided with a corresponding electronic device, which is not limited in the embodiment of the present application. The type of the electronic device is not limited in the embodiment of the present application.

Each type-I embedded control unit has passed related certification for a corresponding function from a third-party certification agency before performing a safety function, such as safety certification. In the embodiments of the present application, the certified standard is not limited, and it may be UL1998, IEC61508, or IEC61131. In other words, respective type-I embedded control units in the control system have passed the related certification, and then cooperate to complete the entire control process. In the control system according to the embodiment of the present application, the first type-I embedded control unit generates, according to functional information stored therein, a functional data packet, where the functional data packet includes functional information and feature code information, and the second type-I embedded control unit performs a checking on the received functional data packet. When the checking is passed, the second type-I embedded control unit performs a corresponding operation according to the functional information; and when it is not passed, do not perform a corresponding operation or determines that the functional data packet is abnormal. Furthermore, regardless of circumstances such as software problems or hardware problems or communication signal interruptions in the type-II embedded control unit, erroneous execution will not be incurred for the type-I embedded control unit, which improves safety and reliability of the control system and avoids invalidity of related certification.

The technical solutions of the present application and how the technical solutions of the present application solve the above-mentioned technical problem will be described in detail below with specific embodiments. The following specific embodiments can be combined with each other, and same or similar concepts or processes may not be repeated in some embodiments. The embodiments of the present application will be described below in conjunction with the drawings.

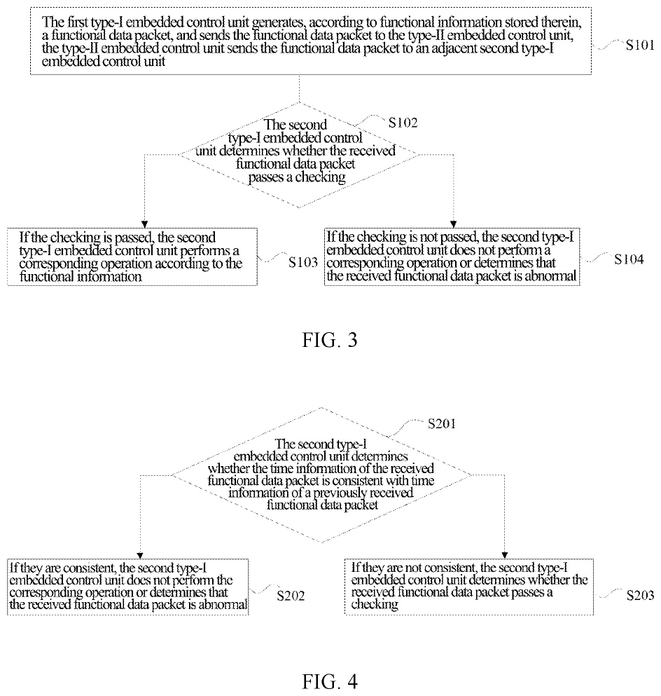

FIG. 2 is a schematic structural diagram of another control system according to an embodiment of the application. FIG. 3 is a schematic diagram of a control process according to an embodiment of the application. The control system provided in the embodiment of the present application completes control of corresponding functions through the control process shown in FIG. 3, where the control system 20 includes:

at least two type-I embedded control units and at least one type-II embedded control unit;

where a type-I embedded control unit 200 communicates with another type-I embedded control unit 400 through the at least one type-II embedded control unit 300.

In the embodiment shown in FIG. 2, description is made by taking an example where the control system 20 has two type-I embedded control units 200 and 400, and the two type-I embedded control units communicate through one type-II embedded control unit 300. Therefore, in the control system provided in this embodiment, the first type-I embedded control unit is the type-I embedded control unit 200, and the second type-I embedded control unit is the other type-I embedded control unit 400. The type-II embedded control unit 300 is connected to the first type-I embedded control unit 200 and the second type-I embedded control unit 400 through communications.

As shown in FIG. 3, the control process provided in the embodiment of the present application includes steps:

S101: the first type-I embedded control unit 200 generates, according to functional information stored therein, a functional data packet, and sends the functional data packet to the type-II embedded control unit 300, the type-II embedded control unit 300 sends the functional data packet to an adjacent second type-I embedded control unit 400, where the functional data packet includes functional information and feature code information.

For each type-I embedded control unit, the embedded control unit generates, according to functional information stored therein, feature code information in the functional data packet.

The algorithm for generating the feature code information according to the functional information may be any mathematical operation whose result has uniqueness, which is not limited in the embodiment of the present application. When the feature code information is generated from the functional information, it can also be performed based on current time information, that is, generating fixed feature code information based on the functional information and the current time information. In an embodiment, the fixed feature code information may also be generated based on other information, that is, based on the functional information and the other information, which is not limited in the embodiment of the present application.

Therefore, the first type-I embedded control unit 200 packs the feature code information and the information on which the feature code information is based, to obtain a functional data packet. The functional data packet is forwarded to the adjacent second type-I embedded control unit 400 through the type-II embedded control unit 300, where the type-II embedded control unit 300 forwards data based on a preset communication protocol. The preset communication protocol may be various communication protocols known to those skilled in the art, which is not limited in this application.

S102: the second type-I embedded control unit 400 determines whether the received functional data packet passes a checking; if the checking is passed, proceed with step S103; if the checking is not passed, proceed with step S104.

S103: the second type-I embedded control unit 400 performs a corresponding operation according to the functional information.

S104: the second type-I embedded control unit 400 does not perform a corresponding operation or determines that the received functional data packet is abnormal.

The type-I embedded control unit that receives the functional data packet, that is, the second type-I embedded control unit 400, performs a checking determination on the functional data packet first, and proceeds with a subsequent process according to a checking result. If the checking is not passed, it indicates that an error occurred during the sending process of the current functional data packet, and the control system for the embedded control unit should stop the current operation, that is, the second type-I embedded control unit 400 does not perform a corresponding operation or determines that the received functional data packet is abnormal. For example, the second type-I embedded control unit 400 may have no response, or may issue an abnormality prompt message to remind the control system that there is an error currently. When the checking is passed, it indicates that there is no error during the sending process of the current functional data packet, and the control system is operating normally.

In this embodiment, the type-I embedded control unit that receives the functional data packet performs a checking on the functional data packet, and the safety function is further executed when the checking is passed. When it is not passed, the second type-I embedded control unit stops the current operation. In this way, it is ensured that the type-I embedded control unit in the control system correctly executes the safety function, the safety and reliability of the control system are ensured, and thus validity of related certification is maintained.

On the basis of the foregoing embodiment, in one possible design, after the second type-I embedded control unit 400 performs, according to the functional information stored therein, a corresponding operation, result information obtained through the operation and other feature code information generated according to the result information are packed and processed to generate another functional data packet. So far, the second type-I embedded control unit 400 has completed its own corresponding safety function. Then the other functional data packet generated by the second type-I embedded control unit 400 is sent to a next type-I embedded control unit through another one or more type-II embedded control units. In an embodiment, the other feature code information can also be generated based on the result information and other information, where the other information can include time information; and the other feature code information and information on which it is based are packed and processed to generate another functional data packet.

By analogy, until the last type-I embedded control unit in the control system performs a checking on the received functional data packet, and after the checking is passed, it completes its own corresponding operation. Thus, the entire control function of the control system is realized through cooperative control of multiple distributed embedded control units.

In one possible design, the functional data packet in the foregoing embodiment may further include other information, and the other information may include time information. When the time information is included, the second type-I embedded control unit 400 also needs to determine whether the time information of the received functional data packet can pass a checking.

The generated functional data packet contains the time information involved in generation of the feature code information. At this time, after receiving the functional data packet, the second type-I embedded control unit 400 determines whether the time information of the received functional data packet passes the checking before determining whether the functional data packet passes the checking.

In other words, after the second type-I embedded control unit 400 receives a functional data packet, it can first determine the timeliness of the functional data packet. Only when the time information of the received functional data packet passes the checking, it is determined whether the functional information of the received functional data packet can pass the checking. Also, it is possible to first determine whether the functional information of the received functional data packet can pass the checking, and then determine whether the time information of the functional data packet passes the checking after the functional data packet passes the checking. Also, it is possible to check the timeliness of the functional data packet and the functional data packet at the same time. In addition, the functional data packet and the timeliness can be checked through the feature code information. This is not limited in the present application.

In one possible design, the second type-I embedded control unit 400 may implement a checking determination of the time information contained in the functional data packet in a manner as shown in FIG. 4. FIG. 4 is a schematic diagram of a timeliness check process according to an embodiment of the application; as shown in FIG. 4, the timeliness check step provided in this embodiment includes:

S201: the second type-I embedded control unit 400 determines whether the time information of the received functional data packet is consistent with time information of a previously received functional data packet;

S202: if they are consistent, the second type-I embedded control unit 400 does not perform the corresponding operation or determines that the received functional data packet is abnormal;

S203: if they are not consistent, the second type-I embedded control unit 400 determines whether the received functional data packet passes a checking.

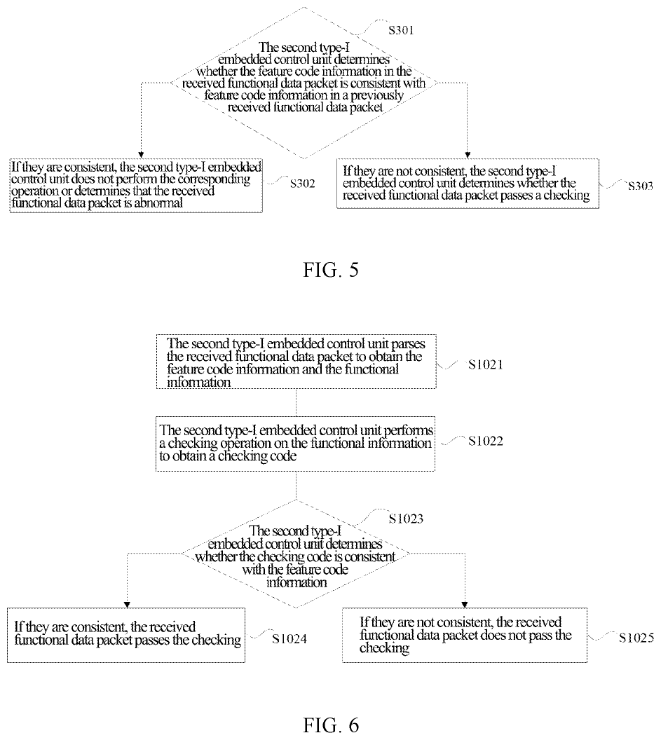

In another possible design, the second type-I embedded control unit 400 determines the timeliness of the functional data packet according to the feature code information before performing the checking determination on the functional data packet. A possible implementation is shown in FIG. 5. FIG. 5 is a schematic diagram of another timeliness check process according to an embodiment of the application; as shown in FIG. 5, the timeliness check step provided in this embodiment includes:

S301: the second type-I embedded control unit 400 determines whether the feature code information in the received functional data packet is consistent with feature code information in a previously received functional data packet;

S302: if they are consistent, the second type-I embedded control unit 400 does not perform the corresponding operation or determines that the received functional data packet is abnormal;

S303: if they are not consistent, the second type-I embedded control unit 400 determines whether the received functional data packet passes a checking.

In the multi-unit cooperative distributed electrical control system provided in this embodiment, the second type-I embedded control unit first determines the timeliness of the functional data packet before performing a checking determination on the received functional data packet. For example, the functional data packet directly contains time information, and it is determined whether the time information in the currently received functional data packet is consistent with time information in a previously received functional data packet. If they are consistent, the second type-I embedded control unit does not perform the corresponding operation or determines that the received functional data packet is abnormal, so as to prompt the control system that there is an error currently. Conversely, if they are not consistent, it indicates that the timeliness of the currently received functional data packet has passed the checking, and it can be further determined whether the functional data packet can pass the checking. Another way is that the second type-I embedded control unit determines the feature code information in the functional data packet, that is, determining whether the feature code information in the currently received functional data packet is consistent with previous feature code information. If they are consistent, the second type-I embedded control unit does not perform the corresponding operation or determines that the received functional data packet is abnormal, so as to prompt the control system that there is an error currently. If they are not consistent, it is further determined whether the functional data packet can pass the checking. According to the checking method provided in this embodiment, the timeliness of the functional data packet can be determined, and the safety and reliability of the control system are further improved.

It is worth understanding that the previously received time information or feature code information in the above embodiment is time information or feature code information contained in a functional data packet that is received last time by the second type-I embedded control unit 400.

According to the description of the foregoing embodiment, the second type-I embedded control unit 400 needs to determine whether the received functional data packet can pass the checking. In a possible design, a checking determination step for the functional data packet, that is, a possible implementation of step S102 is shown in FIG. 6. FIG. 6 is a schematic diagram of a checking process of a functional data packet according to an embodiment of the application. The checking steps of the functional data packet include:

S1021: the second type-I embedded control unit 400 parses the received functional data packet to obtain the feature code information and the functional information;

S1022: the second type-I embedded control unit 400 performs a checking operation on the functional information to obtain a checking code;

S1023: the second type-I embedded control unit 400 determines whether the checking code is consistent with the feature code information;

S1024: if they are consistent, the received functional data packet passes the checking;

S1025: if they are not consistent, the received functional data packet does not pass the checking.

The second type-I embedded control unit 400 performs a checking on the received functional data packet. Firstly, parsing the functional data packet to obtain the feature code information and the functional information contained in the functional data packet. It is understandable that the functional information includes result information obtained by a preceding type-I embedded control unit adjacent to the second type-I embedded control unit 400 performing a corresponding operation according to its functional information, and may also include corresponding time information.

After parsing the functional data packet to obtain the functional information, the second type-I embedded control unit 400 further performs a checking operation on the functional information to obtain a checking code.

The checking operation may use an operation algorithm with a checking function, such as a cyclic redundancy check (Cyclic redundancy check, hereinafter referred to as CRC) algorithm, MD4, hash (Hash) algorithm, etc., and is not limited in the embodiment of this application. It is understandable that an operation result is obtained after the checking operation, that is, the checking code is obtained.

The checking code obtained through the checking operation is compared with the feature code information obtained through the parsing, that is, the second type-I embedded control unit 400 determines whether the checking code is consistent with the feature code information. When a determination result shows consistency, it indicates that the functional data packet received by the second type-I embedded control unit 400 has passed the checking, and there is no error during the sending process of the current functional data packet. Conversely, when a determination result shows inconsistency, it indicates that the functional data packet received by the second type-I embedded control unit 400 has not passed the checking, and there may be an error during the sending process of the current functional data packet; then the second type-I embedded control unit 400 does not perform the corresponding operation or determines that the received functional data packet is abnormal, for example, it may issue an abnormality prompt message to prompt the control system that there is an error in the current control process, or it may make no response, which is not limited in the embodiment of this application.

In the electrical control system provided in this embodiment, the second type-I embedded control unit performs a checking determination on the received functional data packet. Only when the functional data packet passes the checking, a corresponding operation is performed; when the checking is not passed, no corresponding operation is performed. Therefore, the safety and reliability of the control system are guaranteed. After the type-II embedded control unit makes software/hardware update or modification, the type-I embedded control unit can still pass related certification.

In a possible design, when a safety function is performed, related certification obtained by the type-I embedded control unit is safety certification.

In a possible design, in the multi-unit cooperative distributed control system provided in the embodiment of the present application, the type-II embedded control unit may include:

one or more of a control module, a display module, and a communication control module, a communication relay module, and a communication conversion module used for communication; or the arrangement may be made according to actual working conditions involved in the control system, which is not limited in the embodiment of the present application.

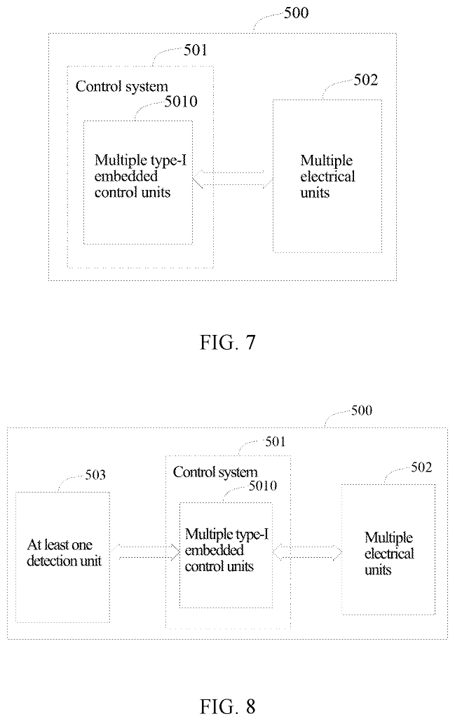

FIG. 7 is a schematic structural diagram of an electrical system according to an embodiment of the application. As shown in FIG. 7, an electrical system 500 provided in the embodiment of the present application includes the multi-unit cooperative distributed electrical control system 501 in the foregoing embodiments, where the electrical system 500 includes:

multiple electrical units 502, and multiple type-I embedded control units 5010 in the control system 501 correspondingly control one or more electrical units. The number of electrical units correspondingly controlled by the multiple type-I embedded control units 5010 can be set according to actual working conditions of the electrical system, which is not limited in the embodiment of the present application. In FIG. 7, description is made by taking an example that the multiple type-I embedded control units 5010 in the control system 501 correspondingly control multiple electrical units 502.

Based on the embodiment shown in FIG.7, FIG. 8 is a schematic structural diagram of another electrical system according to an embodiment of the application. As shown in FIG. 8, the electrical system 500 further includes:

at least one detection unit 503,

where the detection unit 503 can detect an electrical signal of at least one electrical unit 502 and send the detected electrical signal to at least one type-I embedded control unit 5010 that controls the electrical unit, the type-I embedded control unit 5010 receives and correspondingly processes the electrical signal, and stores the electrical signal and/or a processing result as functional information.

In one possible design, based on the embodiment shown in FIG. 7, the electrical system 500 may not include the detection unit 503. The type-I embedded control unit 5010 detects and receives an electrical signal of the electrical unit 502, and correspondingly process the electrical signal, and then stores the electrical signal and/or a processing result as functional information. This is not limited in the embodiment of the present application.

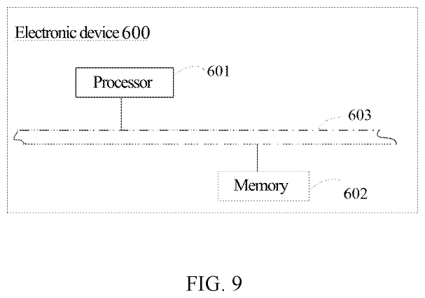

FIG. 9 is a schematic structural diagram of an electronic device according to an embodiment of the application. As shown in FIG. 9, the electronic device 600 provided in this embodiment includes:

at least one processor 601; and

a memory 602 communicatively connected with the at least one processor 601;

where the memory 602 is stored with instructions that can be executed by the at least one processor 601; and the instructions are executed by the at least one processor 601 to enable the at least one processor 601 to execute each step of the control process in the embodiment involved in the above-mentioned electrical control system. For details, reference may be made to relevant description in the foregoing embodiments.

In one possible design, the memory 602 may be independent or integrated with the processor 601.

When the memory 602 is a component independent of the processor 601, the electronic device 600 may also include:

a bus 603 which is used to connect the processor 601 and the memory 602.

In addition, an embodiment of the present application also provides a non-transitory computer-readable storage medium stored with computer instructions. The computer instructions are used to enable a computer to execute each step of the control process in the above-mentioned electrical control systems. For example, the readable storage medium may be an ROM, a random access memory (RAM), a CD-ROM, a magnetic tape, a floppy disk, an optical data storage device, etc.

After considering the specification and practicing the application disclosed herein, those skilled in the art will readily envisage of other embodiments of the present application. This application is intended to cover any variations, uses or adaptations of this application. These variations, uses, or adaptions follow general principles of this application and include common knowledge or conventional technical means in the technical field that is not disclosed in this application. The description and embodiments are only regarded as exemplary, and the true scope and spirit of the application are subject to the claims.

It should be understood that the present application is not limited to the precise structure that has been described above and shown in the drawings, and various modifications and changes can be made without departing from the scope of the present application. The scope of the application is only limited by the appended claims.

What is claimed is:

1. A multi-unit cooperative distributed electrical control system, comprising:
at least two type-I embedded control units and at least one type-II embedded control unit, wherein one of the type-I embedded control units is configured to communicate with the other type-I embedded control unit through the at least one type-II embedded control unit;
wherein a first type-I embedded control unit is configured to generate, according to functional information stored therein, a functional data packet, and send the functional data packet to the type-II embedded control unit, the type-II embedded control unit is configured to send the functional data packet to an adjacent second type-I embedded control unit, and the functional data packet comprises functional information and feature code information;
the second type-I embedded control unit is configured to determine whether the received functional data packet passes a checking;
if the checking is passed, the second type-I embedded control unit is configured to perform a corresponding operation according to the functional information;
if the checking is not passed, the second type-I embedded control unit is configured to not perform a corresponding operation or determines that the received functional data packet is abnormal.

2. The electrical control system according to claim 1, wherein after the second type-I embedded control unit is configured to perform a corresponding operation according to the functional information, at least result information obtained through the operation and at least another feature code information obtained according to the result information are processed to generate another functional data packet, and the other functional data packet is sent to another type-II embedded control unit.

3. The electrical control system according to claim 1, wherein the functional data packet also comprises time information, and the second type-I embedded control unit is also configured to determine whether the time information of the received functional data packet passes a checking.

4. The electrical control system according to claim 1, wherein each type-I embedded control unit is configured to generate, according to functional information stored therein, feature code information in the functional data packet.

5. The electrical control system according to claim 3, wherein the second type-I embedded control unit is also configured to determine whether the time information of the received functional data packet passes a checking, comprising:
the second type-I embedded control unit is configured to determine whether the feature code information of the received functional data packet is consistent with the feature code information in a previously received functional data packet;
if they are consistent, the second type-I embedded control unit is configured to not perform the corresponding operation or determines that the received functional data packet is abnormal;
if they are not consistent, the second type-I embedded control unit is configured to determine whether the received functional data packet passes a checking.

6. The electrical control system according to claim 1, wherein the second type-I embedded control unit is configured to determine whether the received functional data packet passes a checking, comprising:
the second type-I embedded control unit is configured to parse the received functional data packet to obtain the feature code information and the functional information;
the second type-I embedded control unit is configured to perform a checking operation on the functional information to obtain a checking code;
the second type-I embedded control unit is configured to determine whether the checking code is consistent with the feature code information;
if they are consistent, the received functional data packet passes the checking;
if they are not consistent, the received functional data packet does not pass the checking.

7. The electrical control system according to claim 1, wherein the type-I embedded control unit is configured to perform a safety function according to the functional information.

8. The electrical control system according to claim 7, wherein the type-II embedded control unit is further configured to comprise:
at least one of a communication control module, a communication relay module, and a communication conversion module.

9. An electrical system, comprising:
a multi-unit cooperative distributed electrical control system and multiple electrical units, and multiple type-I embedded control units of the control system correspondingly control one or more electrical units, wherein the multi-unit cooperative distributed electrical control system comprising at least two type-I embedded control units and at least one type-II embedded control unit, wherein one of the type-I embedded control units is configured to communicate with the other type-I embedded control unit through the at least one type-II embedded control unit; wherein a first type-I embedded control unit is configured to generate, according to functional information stored therein, a functional data packet, and send the functional data packet to the type-II embedded control unit, the type-II embedded control unit is configured to send the functional data packet to an adjacent second type-I embedded control unit, and the functional data packet comprises functional information and feature code information;
the second type-I embedded control unit is configured to determine whether the received functional data packet passes a checking;
if the checking is passed, the second type-I embedded control unit is configured to perform a corresponding operation according to the functional information;
if the checking is not passed, the second type-I embedded control unit is configured to not perform a corresponding operation or determines that the received functional data packet is abnormal.

10. The electrical system according to claim 9, wherein after the second type-I embedded control unit is configured to perform a corresponding operation according to the functional information, at least result information obtained through the operation and at least another feature code information obtained according to the result information are processed to generate another functional data packet, and the other functional data packet is sent to another type-II embedded control unit.

11. The electrical system according to claim 9, wherein the functional data packet also comprises time information, and the second type-I embedded control unit is also configured to determine whether the time information of the received functional data packet passes a checking.

12. The electrical system according to claim 9, wherein each type-I embedded control unit is configured to generate, according to functional information stored therein, feature code information in the functional data packet.

13. The electrical system according to claim 11, wherein the second type-I embedded control unit is also configured to determine whether the time information of the received functional data packet passes a checking, comprising:
the second type-I embedded control unit is configured to determine whether the feature code information of the received functional data packet is consistent with the feature code information in a previously received functional data packet;
if they are consistent, the second type-I embedded control unit is configured to not perform the corresponding operation or determines that the received functional data packet is abnormal;
if they are not consistent, the second type-I embedded control unit is configured to determine whether the received functional data packet passes a checking.

14. The electrical control system according to claim 9, wherein the second type-I embedded control unit is configured to determine whether the received functional data packet passes a checking, comprising:
the second type-I embedded control unit is configured to parse the received functional data packet to obtain the feature code information and the functional information;
the second type-I embedded control unit is configured to perform a checking operation on the functional information to obtain a checking code;
the second type-I embedded control unit is configured to determine whether the checking code is consistent with the feature code information;
if they are consistent, the received functional data packet passes the checking;
if they are not consistent, the received functional data packet does not pass the checking.

15. The electrical control system according to claim 9, wherein the type-I embedded control unit is configured to perform a safety function according to the functional information.

16. The electrical control system according to claim 15, wherein the type-II embedded control unit is further configured to comprise:
at least one of a communication control module, a communication relay module, and a communication conversion module.

17. The electrical system according to claim 9, further comprising at least one detection unit, wherein the detection unit is configured to detect an electrical signal of at least one of the electrical units and send the electrical signal to at least one type-I embedded control unit, the type-I embedded control unit is configured to receive and then process the electrical signal, and store the electrical signal as functional information.

18. An electronic device, comprising:
at least one processor; and
a memory communicatively connected with the at least one processor;
wherein the memory is stored with instructions that can be executed by the at least one processor; and the instructions are executed by the at least one processor to enable the at least one processor to execute the steps involved in the electrical control system according to claim 1.
